(19) United States
(12) Patent Application Publication
(10) Pub. No.: US 2014/0139519 A1
(43) Pub. Date: May 22, 2014

(54) Method for augmenting reality

(71) Applicant: Orange, Paris (FR)

(72) Inventor: Frederic Mit, Paris (FR)

(21) Appl. No.: 14/078,657

(22) Filed: Nov. 13, 2013

(30) Foreign Application Priority Data
Nov. 13, 2012 (FR) 1260790

(51) Int. Cl. G06T 19/00

(52) U.S. Cl. CPC G06T 19/006
USPC 345/419

(57) ABSTRACT

The present invention relates to a method for generating an enriched image from an image (I) of a three-dimensional scene (S) acquired by optical acquisition means (12) from a reference spatial position, the method comprising the integration into the image (I), by data processing means (11), of at least one graphic object (O1, O2, O3, O4, O5, O6, O7, O8, O9) associated with a spatial position of the scene (S),

the method being characterized in that the data processing means (11) are configured for:
(a) determining for each graphic object (O1, O2, O3, O4, O5, O6, O7, O8, O9) whether the associated spatial position is visible in the scene (S) by a user of said obstacle acquisition means (12) from said reference spatial position;
(b) integrating each graphic object (O1, O2, O3, O4, O5, O6, O7, O8, O9) into the image (I) depending on the result of the determination of visibility.

### GENERAL TECHNICAL FIELD

The present invention relates to the field of augmented reality.

More specifically, it relates to a method for generating an enriched image from an image of a scene.

### STATE OF THE ART

Augmented reality (AR) is a technology giving the possibility of completing in real time a survey of the world as we perceive it with virtual elements. It applies both to visual perception (superposition of a virtual image on real images) and to proprioceptive perceptions such as tactile or auditory perceptions.

In its <<visual>> component, augmented reality consists of realistically inlaying computer-generated images into a sequence of images, most often filmed live, for example with a camera of a smartphone.

The goal is most often to provide the user with information on his/her environment, in the way made possible by a <<head-up display>>.

The possibilities are then multiple: augmented reality may help a passerby in finding a path, a tourist in discovering monuments, a consumer in selecting shops etc. Moreover, augmented reality may quite simply be an entertaining means.

Synthetic images are generated by a computer (for example by the processor of the smartphone) from diverse data and synchronized with the <<actual>> view, by analyzing the sequence of images. For example, by orienting the smartphone towards a building, it is possible to identify the geographic location and the orientation of the camera by means of GPS and an integrated compass.

In many applications, the synthetic images added to the actual scene consist in text panels or pictograms, informing the user on particular surrounding elements, whether these are monuments, shops, bus stops, crossroads, etc. The <<panel>> is inlaid into the image as if it was present at the associated particular element. Mention may for example be made of an augmented reality real estate application which displays the square meter price on the observed building.

However, it is seen today that virtual reality technologies may be improved. It is seen in FIG. 1, which again takes up the example of the real estate application, that certain views are found to cause a highly confusing display and disconcerting for the user.

The inlay of synthetic images alters the reality here rather than improving it and the experience of the user is no longer satisfactory.

An improvement of the existing methods for augmenting reality would therefore be desirable.

### PRESENTATION OF THE INVENTION

Thus according to a first aspect, the invention relates to a method for generating an enriched image from an image of a three-dimensional scene acquired by optical acquisition means from a reference spatial position, the method comprising the integration into the image, by data processing means, of at least one graphic object associated with a spatial position of the scene;

the method being characterized in that the data processing means are configured for:

(a) determining for each graphic object whether the associated spatial position is visible in the scene by a user of said optical acquisition means from said reference spatial position;

(b) integrating each graphic object into the image depending on the result of the determination of visibility.

The fact of enriching the image by only displaying the graphic objects which would be visible in the real world (and not those which are seen <<through>> obstacles, or by displaying them differently) makes the display more natural and reinforces its realism.

According to other advantages and non-limiting features:
the method comprises the application by the data processing means of a prior step for generating each graphic object, each generated graphic object being integrated into the image in step (b) only if it is determined as being visible.
This allows preparation of all the potentially visible graphic objects for the user, and their display or not according to his/her displacements (and therefore according to the time-dependent change in his/her line of sight).
the determination of visibility of step (a) consists for each graphic object in an intersection test between:
   a segment having for ends the spatial position associated with the graphic object and said reference spatial position; and
   three-dimensional modeling of the scene.

This test method gives the possibility of securely and easily determining the visibility or not of a graphic object.
The data processing means are connected with a server via a network, the server being able to provide said three-dimensional modeling of the scene (this connected mode uses loaded three-dimensional modeling on a case by case basis for limiting the required resources);
the method comprises the application by the geolocalization means connected to the data processing means of a prior step for localizing and orienting said three-dimensional scene (geolocalization gives the possibility of facilitating the handling of augmented reality);
the method comprises the sending to the server of a request for data of said three-dimensional modeling of the scene according to the obtained localization and orientation data of said three-dimensional scene (by combining geolocalization and the use of a server providing three-dimensional modeling data, it is possible to obtain an optimum dynamic operation);
the integration of each graphic object into the image comprises an adjustment of the size of the graphic object according to the spatial position associated with the graphic object (adjustment of the size informs the user on the spatial position associated with the graphic object);
said adjustment of the size of each graphic object is proportional to the distance between the spatial position associated with the virtual object and said reference spatial position (this homothety gives to the graphic objects a behavior similar to that of a real sign, for more realism);
the data processing means and optical acquisition means are those of a mobile terminal, the mobile terminal further comprising means for displaying said enriched image.

According to a second aspect, the invention relates to a mobile terminal comprising optical acquisition means configured for acquiring at least one image of a three-dimensional scene from a reference spatial position of the scene, and data processing means configured for integrating into the image at least one graphic object associated with a spatial position of the scene;

the mobile terminal being characterized in that the data processing means are further configured for determining for each graphic object whether the associated spatial position is visible in the scene by a user of said optical acquisition means from said reference spatial position, and integrating each graphic object into the image depending on the result of the determination of visibility.

A mobile terminal is actually the optimum tool for applying a method for enriching reality, insofar that it combines in a portable way, data processing means and optical acquisition means.

According to other advantages and non-limiting features, the mobile terminal further comprises geolocalization means and means for connecting via a network to a server on data storage means on which are stored data relating to three-dimensional modeling of the scene. Most mobile terminals indeed have connection to Internet which gives the possibility of transmitting to the server the geolocalization data and retrieving back from the request the three-dimensional modeling data for applying the method.

According to a third and fourth aspect, the invention respectively relates to a computer program product comprising code instructions for executing a method for generating an enriched image from an image of a three-dimensional scene acquired by optical acquisition means according to the first aspect of the invention; and a storage means legible by computer equipment on which a computer program product comprises code instructions for executing a method for generating an enriched image from an image of a three-dimensional scene acquired by optical acquisition means according to the first aspect of the invention.

### PRESENTATION OF THE FIGURES

Other features and advantages of the present invention will become apparent upon reading the description which follows of a preferential embodiment. This description will be given with reference to the appended drawings wherein:

FIG. 1 described earlier illustrates a display in augmented reality according to the prior art;

FIG. 2 is a diagram of an architecture for applying a preferred embodiment of the method according to the invention;

FIGS. 3a-3b are two screen captures illustrating the application of a preferred embodiment of the method according the invention.

### DETAILED DESCRIPTION

### Principle

The method according to invention is a method for generating an enriched image from an image I of a three-dimensional scene S acquired by optical acquisition means 12 from a reference spatial position of the scene S. It therefore begins with a step for acquiring at least one image I of a three-dimensional scene S by the optical acquisition means 12 from a reference spatial position of the scene S.

As this will be explained later on, the present method is most particularly intended to be applied by a mobile terminal (a smartphone, a touchpad, etc.) which incorporates optical acquisition means 12, notably as a small camera.

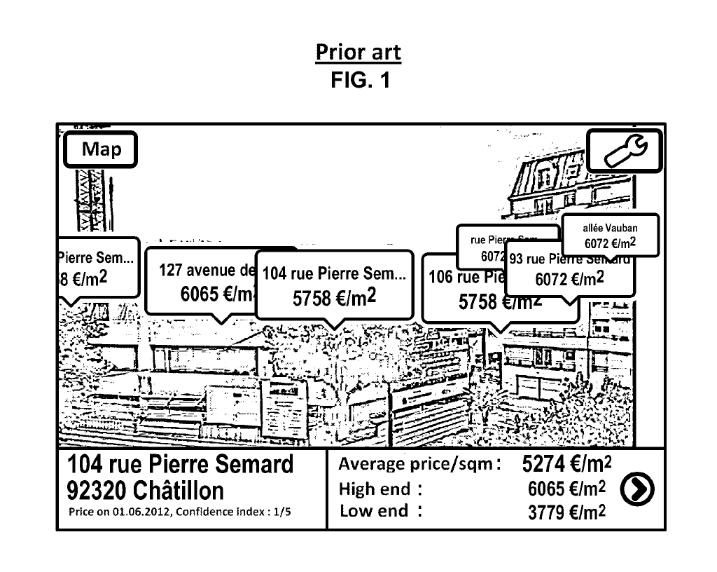

In FIG. 1, a mobile terminal is illustrated, comprising a back camera 12.

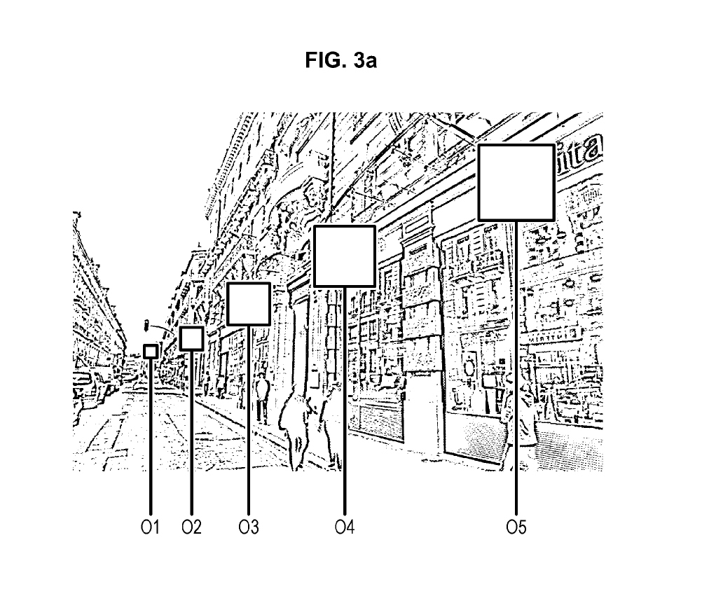

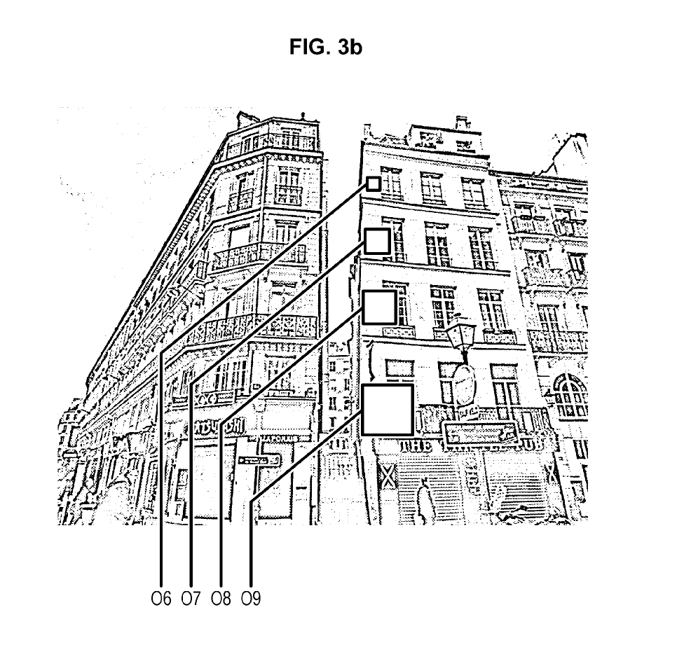

A mobile terminal 1 actually gives the possibility of easily acquiring an image anywhere, the mentioned three-dimensional scene S most often being an urban landscape as seen in FIGS. 3a and 3b. This is a scene of reality, more specifically the visible portion of the real world, contemplated via optical acquisition means 12, projected in two dimensions during acquisition of the image I.

The reference spatial position is the position of the objective of the optical acquisition means 12 (in the form of a coordinate triplet) in a reference system of the scene S. This reference spatial position approximates that of the eyes of the user within the scene S.

It will be noted that by at least one image I, is meant either one or several isolated images, or a succession of images, in other words a video. The present method is actually quite adapted to continuous operation (i.e., an image-by-image enrichment of the obtained film).

In one case like in the other, the screens 13 of present mobile terminals may display in real time the image I enriched at the end of the method, which gives the possibility of moving while observing via the screen 13 the scene S which would be seen if it were possible to see “through” the mobile terminal 1, but enriched with information (in other words “augmented” reality).

However, it will be understood that the method is not limited to mobile terminals. For example, it is quite possible to film a shot in a street with a digital camera (recorded as a video digital sequence on storage means such as a mini DV cassette), and then to enrich a posteriori this sequence via a workstation at which the acquired sequence is read.

By enrichment, is conventionally meant the integration into the image I of at least one graphic object O1, O2, O3, O4, O5, O6, O7, O8, O9 (see FIGS. 3a and 3b) associated with a spatial position of the scene S.

The graphic objects are virtual objects superposed to the reality. They may be of any kinds, but as seen in the example of FIG. 1, they most often assume the shape of a panel or of a bubble displaying information relating to the spatial position which it indicates. For example, if the enrichment is aimed at indicating shops, each graphic object may indicate the name of a shop, its opening hours, telephone number, etc. In another case, the enrichment may aim at indicating Wi-Fi hot spots (a place for wireless access to the Internet). The graphic objects may then represent, as a number of bars or as a color, the quality of the Wi-Fi signal. One skilled in the art will know how to enrich in a varied way any image I of a scene S with data of his/her choice. The invention is by no means limited to showing the information.

The spatial position with which a graphic object O1, O2, O3, O4, O5, O6, O7, O8, O9 is associated, is a triplet of space coordinates (in the same reference system as the reference spatial position) in close proximity to the location of the scene S which it indicates.

The integration is applied so that each graphic object O1, O2, O3, O4, O5, O6, O7, O8, O9 coincides in said enriched image I with the representation of the spatial position of the associated scene S, the idea being to simulate the presence of the graphic object in the scene S in the expected position.

In FIG. 3a, the graphic objects O1, O2, O3, O4, O5 indicate shops. The associated spatial positions therefore correspond to a point in space located at the shop window of each shop, so that each graphic object simulates a sign.

In FIG. 3b, the graphic objects O6, O7, O8, O9 indicate apartments. The associated spatial positions therefore correspond to a point in space located on the frontage of each apartment, so that each graphic object simulates a sign.

This integration is accomplished with data processing means 11, typically the processor of the mobile terminal 1 via which acquisition of the image I is accomplished, but as explained earlier, this may be a processor of any other piece of computer equipment if the processing is accomplished a posteriori. It should be noted that the processing means 11 may comprise more than one processor, the computation power required for the method may for example be shared between the processor of the mobile terminal 1 and that of a server 3 (see further on).

It will be understood that the integration mechanisms are known to one skilled in the art and that the latter will be able to adapt them to any desired application of image enrichment. In particular, techniques for positioning graphic objects will be discussed subsequently.

What makes the specificity of the method object of the invention here is that the data processing means 11 are further configured for:
(a) determining for each graphic object O1, O2, O3, O4, O5, O6, O7, O8, O9 whether the associated spatial position is visible in the scene S by a user of said optical acquisition means 12 from said reference spatial position;
(b) integrating each graphic object O1, O2, O3, O4, O5, O6, O7, O8, O9 into the image I depending on the result of the determination of visibility.

In other words, for each graphic object, a test is carried out in order to know whether an instance of the graphic object in the reality would be visible, the display of each graphic object depending on its visibility.

Advantageously, only the objects satisfying this test are actually integrated (and displaced) in the image I. In other words, the integration of each graphic object O1, O2, O3, O4, O5, O6, O7, O8, O9 into the image is only carried out if the spatial position associated with the graphic object O1, O2, O3, O4, O5, O6, O7, O8, O9 is visible in the scene S from said reference spatial position, the objects determined as being invisible are not displayed.

Indeed, the known methods content themselves with displaying the whole of the graphic objects located in a given circle around the user (i.e. the reference spatial position). This causes display of “impossible” objects, and very little legibility as is observed in FIG. 1.

The test gives the possibility of limiting the number of displayed objects and thus of approaching the reality in which only a fraction of the shops in our vicinity is in our line of sight, the visibility of those of the neighboring streets being blocked by the surrounding buildings.

It will be understood that the method according to invention is not limited to an exclusive display of the sole visible objects, and that it is quite possible to provide that all or part of the invisible objects are nevertheless illustrated, for example in grey or in dotted lines. Also, provision may be made for certain graphic objects to be systematically displayed, for example, public transport stops, so as to be able to go there easily even if they are not yet visible.

### Visibility Test

Preferably, the whole of the graphic objects O1, O2, O3, O4, O5, O6, O7, O8, O9 which are “theoretically visible” is generated, and the test is then carried out on each of them in order to only retain those which are actually visible.

Thus, the method comprises the application by the data processing means 11 of a prior step for generating each graphic object O1, O2, O3, O4, O5, O6, O7, O8, O9, each generated graphic object being integrated into the image I in step b only if it is determined as being visible, with aforementioned exceptions in which the invisible determined objects are nevertheless illustrated, but differently (in grey, in dotted lines, etc.).

In other terms, the data processing means 11 apply steps for:
generating at least one graphic object O1, O2, O3, O4, O5, O6, O7, O8, O9 which may be “integrated” into the image I;
determining for each generated graphic object O1, O2, O3, O4, O5, O6, O7, O8, O9 the visibility or not of the associated spatial position in the scene S from said reference spatial position;
integrating into the image I each graphic object for which the associated spatial position is determined as being visible.

It will also be understood that it is possible to operate in the reverse direction, i.e. by determining the whole of the visible spatial positions and then by generating the associated graphic objects O1, O2, O3, O4, O5, O6, O7, O8, O9.

However, with view of continuous application and in real time by a moving user (in streets for example), it is preferable to generate “in advance” all the graphic objects, and then have them appear (or disappear) according to the displacements of the user (and therefore according to the reference spatial position).

Preferably, the visibility test is an intersection test between
a segment having for ends the spatial position associated with the graphic object O1, O2, O3, O4, O5, O6, O7, O8, O9 and said reference spatial position (a segment which corresponds to the line of sight of the object); and
three-dimensional modeling of the scene S.

Knowing the coordinates of both ends of the segment and having the modelling data, it is easy to conduct the tests by covering the segment from one end to the other. For each point, it is tested whether this point belongs to the three-dimensional modeling of the scene. If yes, there is obstruction and the spatial position associated with the graphic object is not visible.

Such three-dimensional modelings of reality are known and available (mention will for example be made of MapsGL from Google) most often via the Internet network.

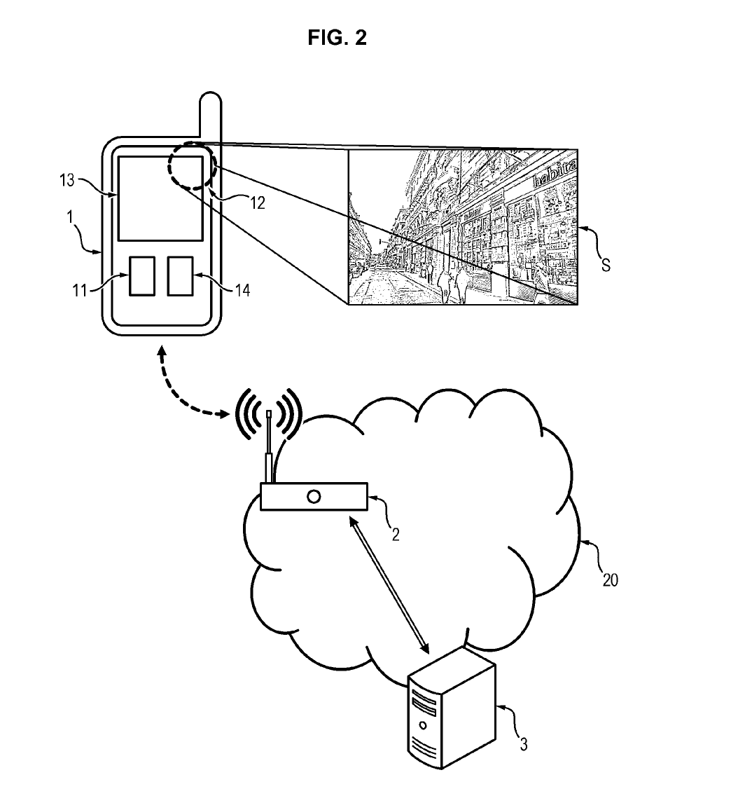

With reference to FIG. 2, the mobile terminal may be connected to a server 3 through the Internet network 20. For completely free operation, the connection may pass through a wireless network such as the 3G network and antennas 2.

The three-dimensional modeling of the scene S may be stored on the server 3. More specifically, modeling of a vast area containing scene S is stored on the server 3. The data relating to the sub-portion corresponding to the scene S alone may be extracted on request from processing means 11. Alternatively, the test of visibility is carried out at the server 3 and the latter sends back the results (in other words, the extreme end positions of the “vision” segment are transmitted to the server 3).

Advantageously, the method comprises the application by geolocalization means 14 connected to the data processing means 11 of a preliminary step for localization and orientation of said three-dimensional scene S. In the case of a mobile terminal 1, these geolocalization means 14 may for example consist in the combination of a GPS and of a compass. With this step, it is possible to determine which is the observed scene, and if necessary to send to the server 3 a request for data of said three-dimensional modeling of the scene S according to the data obtained for localization and orientation of said three-dimensional scene S.

Alternatively, or additionally, the processing means 11 may apply an analysis of the image I for comparison with data banks for identifying the scene S.

In every case, it will be understood that the possibilities for applying the method are multiple and that the invention is not limited to any particular technique as regards the test of the visibility of the spatial position associated with a graphic objection.

It should be noted that the server 3 (or a distinct server) may also first be used as a database of information for generating graphic objects O1, O2, O3, O4, O5, O6, O7, O8, O9. For example, if the example in which indication of the shops is desired, is again taken up, this database may be a list of shops, each associated with coordinates (which will be used as a basis for the spatial position associated with a corresponding graphic object) and with tags such as the opening hours or the telephone number of the shop.

The request sent to the server 3 may thus be a request for information on shops in proximity to the user (depending on the reference position) in order to generate the graphic objects O1, O2, O3, O4, O5, O6, O7, O8, O9. All this data may alternatively be locally stored in the mobile terminal 1, or even inferred from the image I by image analysis (for example recognition of logos).

### Adjustment of the Size

In addition to the visibility test, the method object of the invention proposes another improvement in the known enrichment methods in order to make the enriched image more realistic and to improve user experience.

Thus, the integration of each graphic object O1, O2, O3, O4, O5, O6, O7, O8, O9 into the image I advantageously comprises an adjustment of the size of the graphic object O1, O2, O3, O4, O5, O6, O7, O8, O9 depending on the spatial position associated with the graphic object O1, O2, O3, O4, O5, O6, O7, O8, O9. Preferably, this size adjustment is proportional to the distance between the spatial position associated with the virtual object O1, O2, O3, O4, O5, O6, O7, O8, O9 and said reference spatial position (in other words the length of the “vision” segments as defined earlier).

The size of a graphic object thus informs the user on the position of the location to be reached, and informs him/her on the distance to be covered and the required time, as in reality a shop sign would give such information.

As seen in FIGS. 3a and 3b, the size adjustment indicates both a distance in the plane (O1<O2<O3<O4<O5) and along z (O6<O7<O8<O9).

This allows a more natural display than the one of FIG. 1, in which an adjustment in size of the graphic objects does not depend on the distance but only on the congestion (when several graphic objects are superposed, their size is reduced).

### Mobile Terminal

According to a second aspect, the invention relates to a mobile terminal for applying the method for generating an enriched image, as the one illustrated in FIG. 2.

Thus, this mobile terminal 1, as explained, comprises at least optical acquisition means 12 configured for acquiring at least one image I of a three-dimensional scene S from a reference spatial position of scene S, and data processing means 11. This may be any known piece of equipment such as a smartphone, a touchpad, an ultra-portable PC, etc.

The data processing means 11 are therefore configured not only for integrating into the image I at least one graphic object O1, O2, O3, O4, O5, O6, O7, O8, O9 associated with a spatial position of the scene S, but also for determining for each graphic object O1, O2, O3, O4, O5, O6, O7, O8, O9 whether the associated spatial position is visible in the scene S by a user of said optical acquisition means 12 from said reference spatial position, and integrating each graphic object O1, O2, O3, O4, O5, O6, O7, O8, O9 into the image I depending on the result of the determination of visibility.

As explained, the invisible objects may be displayed differently or quite simply not integrated into the image I.

Additionally, the mobile terminal 1 advantageously comprises display means 13 (allowing the image I to be viewed, before and/or after enrichment), geolocalization means 14 and connection means 15 via a network 20 to the server 3 described earlier, for recovering general data useful for generating the graphic objects and/or data relating to three-dimensional modeling of the scene S.

### Computer Program Product

According to a third and fourth aspect, the invention relates to a computer program product comprising code instructions for executing (on data processing means 11, in particular those of a mobile terminal 1) a method for generating an enriched image from an image I of a three-dimensional scene S acquired by optical acquisition means 12 according to the first aspect of the invention, as well as storage means which are legible by computer equipment (for example a memory of this mobile terminal 1) on which this computer program product is found.

1. A method comprising:
generating an enriched image from an image of a three-dimensional scene acquired by optical acquisition means for acquiring images from a reference spatial position; and
integrating into the image, by a data processor, at least one graphic object associated with a spatial position of the scene, wherein integrating comprises:
(a) determining for each graphic object if the associated spatial position is visible in the scene by a user of said optical acquisition means from said reference spatial position; and
(b) integrating each graphic object into the image depending on the result of the determination of visibility, the integration of each graphic object into the image comprising an adjustment of a size of the graphic object depending on the spatial position associated with the graphic object.

2. The method according to claim 1, comprising application by the data processor of a preliminary step of generating each graphic object, each generated graphic object being integrated into the image in step (b) only if it is determined as being visible.

3. The method according to claim 1, wherein the determination of visibility of step (a) comprises for each graphic object in an intersection test between:
a segment having for ends the spatial position associated with the graphic object and said reference spatial position; and
three-dimensional modeling of the scene.

4. The method according to claim 3, wherein the data processor is connected with a server via a network, the method including the processor receiving said three-dimensional modeling of the scene from the server.

5. The method according to claim 1, comprising application by means for geolocalization connected to the data processing processor of a preliminary step of localization and orientation of said three-dimensional scene.

6. The method according to claim 5, wherein the determination of visibility of step (a) comprises for each graphic object in an intersection test between: a segment having for ends the spatial position associated with the graphic object and said reference spatial position; and three-dimensional modeling of the scene, the method further
comprising:
receiving said three-dimensional modeling of the scene from the server; and
sending to the server a request for data of said three-dimensional modeling of the scene according to the obtained data for localization and orientation of said three-dimensional scene.

7. The method according to claim 1, wherein said adjustment of the size of each graphic object is proportional to the distance between the spatial position associated with the virtual object and said reference spatial position.

8. The method according to claim 1, further comprising:
implementing the data processor and the optical acquisition means within a mobile terminal and displaying said enriched image on a display of the mobile terminal.

9. A mobile terminal comprising:
optical acquisition means for acquiring at least one image of a three-dimensional scene from a reference spatial position of the scene, and
a data processor configured for:
integrating into the image at least one graphic object associated with the spatial position of the scene;
for determining for each graphic object whether the associated spatial position is visible in the scene by a user of said optical acquisition means from said reference spatial position; and
integrating each graphic object into the image depending on the result of a determination of visibility, the integration of each graphic object into the image comprising adjustment of a size of the graphic object depending on the spatial position associated with a graphic object.

10. The mobile terminal according to claim 9, further comprising means for obtaining geolocalization information and means for connection via a network to a server and receiving data relating to the three-dimensional modeling of the scene from the server.

11. (canceled)

12. A non-transitory computer-readable storage device, comprising a computer program product stored thereon, which comprises code instructions for executing a method for generating an enriched image from an image of a three-dimensional scene acquired by optical acquisition device, when executed by a computer, wherein the method comprises the following steps performed by the computer:
obtaining the image of the three-dimensional scene from the optical acquisition device;
generating the enriched image from the image of the three-dimensional scene from a reference spatial position; and
integrating into the image at least one graphic object associated with a spatial position of the scene, wherein integrating comprises:
determining for each graphic object if the associated spatial position is visible in the scene by a user of said optical acquisition device from said reference spatial position; and
integrating each graphic object into the image depending on the result of the determination of visibility, the integration of each graphic object into the image comprising an adjustment of a size of the graphic object depending on the spatial position associated with the graphic object.
